(19) United States
(12) Patent Application Publication
(10) Pub. No.: US 2024/0370215 A1
(43) Pub. Date: Nov. 7, 2024

(54) AUTOMATIC PRINTER SELECTION FOR UNIVERSAL PRINTER DRIVER

(71) Applicant: Hewlett-Packard Development Company, L.P., Spring, TX (US)

(72) Inventors: Sangmin LEE, Seongnam Si (KR); Jeonghun KIM, Seongnam Si (KR); Deokhee BOO, Seongnam Si (KR); Mikyung CHOI, Seongnam Si (KR); Junyoung CHOI, Seongnam Si (KR)

(21) Appl. No.: 18/687,480

(22) PCT Filed: Feb. 1, 2022
(86) PCT No.: PCT/US2022/014662

§ 371 Date: Feb. 28, 2024

(30) Foreign Application Priority Data
Aug. 31, 2021 (KR) 10-2021-0115287

(51) Int. Cl. G06F 3/12; G06F 9/4401

(52) U.S. Cl. CPC G06F 3/1293; G06F 3/1204; G06F 3/1228; G06F 3/1236; G06F 3/1286; G06F 9/4411

(57) ABSTRACT

An example information processing apparatus is to receive a network event, detect, based on the network event, whether the information processing apparatus is attached to a new-in-driver-perspective network, if it is detected that the information processing apparatus is attached to the new-in-driver-perspective network, detect whether there remains available in the new-in-driver-perspective network a destination printer that is already set for use by a universal printer driver (UPD) of the information processing apparatus in a previously attached network, and, if it is detected that the already set destination printer remains available, automatically set the already set destination printer as a destination printer of the UPD in the new-in-driver-perspective network. The new-in-driver-perspective network includes a network to which the information processing apparatus has not been attached or a network in which a destination printer of the UPD has automatically been set and not been used.

### BACKGROUND

There exist different types of image forming devices including printers, scanners, copiers, facsimile machines, etc., and also multi-function products (MFPs) that act as an all-in-one solution to provide a combination of, e.g., printing, copying, scanning, and faxing functions.

There may be installed in a user device a printer driver for control of a print functionality of an image forming device. The user device may use one universal printer driver (UPD) to control the print functionality for a plurality of image forming devices that are networked-connected in a local or remote manner.

### BRIEF DESCRIPTION OF THE DRAWINGS

Various examples will be described below by referring to the following figures.

FIG. 1 is a diagram conceptually illustrating an information processing apparatus in which a function of automatic printer selection may be implemented for a universal printer driver (UPD) according to an example.

FIG. 2 is a diagram illustrating a table for generation and management of a network identifier according to an example.

FIG. 3 is a flow diagram depicting operations of an automatic printer selection for a UPD according to an example.

FIG. 4 is a flow diagram depicting operations for detecting whether an information processing apparatus is attached to a new-in-driver-perspective network according to an example.

FIG. 5 is a flow diagram depicting operations for detecting whether an already set destination printer is available in a new-in-driver-perspective network according to an example.

FIG. 6 is a diagram depicting operations for updating use history information for reference in some operations of an automatic printer setting for a UPD according to an example.

FIG. 7 shows an interface for presenting information regarding an automatically set destination printer according to an example.

FIGS. 8 to 10 are flow diagrams illustrating example methods of setting up a UPD.

FIG. 11 is a schematic illustration of a non-transitory computer readable recording medium including example instructions.

FIG. 12 is a diagram illustrating an environment in which a destination printer may be automatically set for a UPD according to an example.

### DETAILED DESCRIPTION

Examples of the present disclosure relate to a technology of providing a universal printer driver (UPD). A UPD is a driver that supports single-driver usage by a user's information processing apparatus across a plurality of image forming devices. For example, performing a print job using the UPD may involve selecting, based on an input of the user or a previous history of use in a current network environment, from among image forming devices supported by the UPD in the current network environment, an image forming device to use in the print job and performing the print job through the selected image forming device.

However, in a situation in which the information processing apparatus with the UPD installed therein is moved to another network environment to which the information processing apparatus has not been attached, the same selection process is repeated so as to select an image forming device to use through the UPD in the other network environment. In this selection process, the user might be prompted to select an image forming device by which the print job is to be performed through the UPD.

In accordance with an example, there is provided a technology with which, based on entering a new network environment and performing a print job through a UPD, an information processing apparatus detects whether there is available in the new network environment a destination image forming device that is set for use by the UPD in a previous network environment or an image forming device that is specified by a user. Based thereon, the information processing apparatus automatically sets an image forming device to be used by a UPD, thereby providing the user with an enhanced user experience in performing the print job through the UPD in the new network environment.

Various terms used in the present disclosure are chosen from a terminology of commonly used terms in consideration of their function herein, which may be appreciated differently depending on an intention, a precedent case, or an emerging new technology. Accordingly, the terms used herein are to be defined consistently with their meanings in the context of the present disclosure, rather than simply by their plain and ordinary meaning.

The terms “comprising,” “including,” “having,” “containing,” etc. are used herein to specify the presence of the elements listed thereafter. Unless otherwise indicated, these terms and variations thereof are not meant to exclude the presence or addition of other elements.

As used herein, the ordinal terms “first,” “second,” and so forth are meant to identify several similar elements. Unless otherwise specified, such terms are not intended to impose limitations, e.g., a particular order of these elements or of their use, but rather are used merely for referring to multiple elements separately. For instance, an element may be referred to in an example with the term “first” while the same element may be referred to in another example with a different ordinal number such as “second” or “third.” In such examples, such ordinal terms are not to limit the scope of the present disclosure. Also, the use of the term “and/or” in a list of multiple elements is inclusive of all possible combinations of the listed items, including any one or a plurality of the items.

The term “image forming job” as used herein may encompass any of a variety of image-related jobs that involve an operation of forming an image and/or other processing operation, e.g., creation, generation and/or transfer of an image file, etc. The term “job” as used herein may encompass a chain of processes that facilitate an image forming job, as well as the image forming job per se. By way of example, an image forming device may perform an image forming job, such as a print job, a copy job, a scan job, a facsimile or other transmission job, a storage job, a coating job, or the like.

The term “image forming device” or “image forming apparatus” as used herein may encompass any of a variety of devices, such as a printer, a copier, a scanner, a facsimile machine, a multi-function product (MFP), a display device, and the like, that are capable of performing an image forming job. In some examples, an image forming device may be a two-dimensional (2D) or a three-dimensional (3D) image forming device. Such image forming device may provide various additional functions, as well as basic ones, for example, printing, copying, scanning, and facsimile or other transmission functions.

The term “user” as used herein may refer to a person who manipulates an image forming device to perform an image forming job. Further, the term “administrator” as used herein may refer to a person who has access to the entire functionality of an image forming device. In some examples, one person may have both roles of an administrator and a user.

The terms “electronic device,” “electronic apparatus,” or “user device” as used herein may refer to any information processing device, such as, for example, a computer, a laptop, a desktop PC, a tablet, a mobile telephone terminal, or the like, that may be used by a user.

The term “universal printer driver (UPD)” may refer to a driver that facilitates single-print-driver control and management of operations of at least one printer.

Examples of the present disclosure will now be described with reference to the accompanying drawings. The present disclosure may, however, be embodied in many different forms and should not be construed as limited to the examples set forth herein. Rather, these examples are given in order to provide a better understanding of the scope of the present disclosure.

These and other features of the examples will become apparent from the following description taken in conjunction with the accompanying drawings.

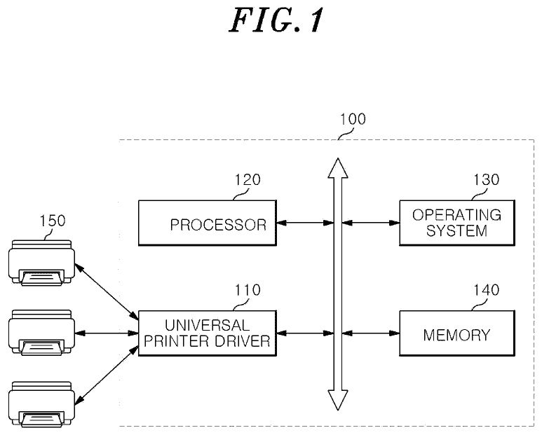

FIG. 1 is a diagram conceptually illustrating an information processing apparatus in which a function of automatic printer selection may be implemented for a universal printer driver (UPD) according to an example.

Referring to FIG. 1, an information processing apparatus 100 may include a UPD 110, a processor 120, an operating system 130, and a memory 140. Other configurations of the information processing apparatus 100 are also contemplated. In an example, the information processing apparatus 100 may also include an additional component, e.g., a power supply unit to supply power to the above-mentioned components, a user interface unit, a communications unit to communicate with an external entity, or the like. In another example, the information processing apparatus 100 may include some of, but not all of, the components shown in FIG. 1. Further, it may be appreciated that the information processing apparatus 100 may be a single device or may be implemented with a plurality of interconnected devices.

The UPD 110 is a component by which the information processing apparatus 100 controls a function of an image forming device (e.g., any of image forming devices 150), such as a print job. As such, the information processing apparatus 100 may use the UPD 110 to control each of the plurality of image forming devices 150, instead of having installed therein respective printer drivers for control of the plurality of image forming devices 150. Accordingly, in order for the information processing apparatus 100 to perform a print job through the UPD 110, a destination printer for use through the UPD 110 may be selected from among the plurality of image forming devices 150 that are connected via a wired and/or wireless network to the information processing apparatus 100.

In an example, the processor 120 may control an operation of the information processing apparatus 100. For example, the processor 120 may be implemented with a central processing unit (CPU), a graphics processing unit (GPU), or other processing circuitry to perform example operations described herein. In some examples, the processor 120 may execute an instruction stored in the memory 140. The processor 120 may also read other information stored in the memory 140. In addition, the processor 120 may store new information in the memory 140 and may update some information stored in the memory 30.

In an example, if there occurs an event related to a network to which the information processing apparatus 100 is attached, the information processing apparatus 100, e.g., the processor 120 thereof, may receive the network event from the operating system 130. Such network event may be caused by a change of the network to which the information processing apparatus 100 is attached, by a user starting up the information processing apparatus 100 and logging in to the operating system 130, or by other circumstances. In response to receiving the network event, the processor 120 of the information processing apparatus 100 may request and receive, from the operating system in control of a network device, a network identifier which serves as information about the network to which the information processing apparatus 100 is currently attached.

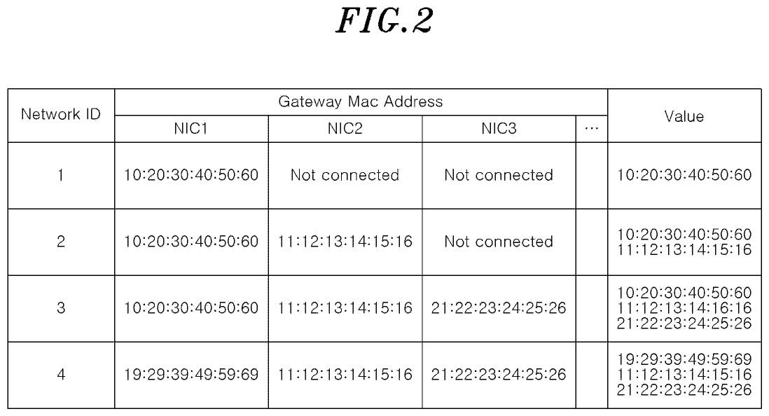

FIG. 2 is a diagram illustrating a table for generation and management of a network identifier according to an example.

Referring to FIG. 2, a network identifier may be an identifier that uniquely identifies a network environment to which the information processing apparatus 100 is currently attached. The network identifier may be generated using a MAC address of a gateway to which the information processing apparatus 100 is connected and may be stored in the memory 140 of the information processing apparatus 100 or a separate repository that is accessible to the information processing apparatus 100. The information processing apparatus 100 may be connected to one or a plurality of networks and have a network device, e.g., a network interface card (NIC), for each network connection. For example, the information processing apparatus 100 may have two NICs, each of which supports attachment to a wired network, and one NIC which supports attachment to a wireless network. The network environment to which the information processing apparatus 100 is currently attached may be uniquely identified by combining the MAC addresses of the gateways respectively connected with the NICs to uniquely generate a network identifier and its value.

In the example of FIG. 2, the information processing apparatus 100 has three NICs: NIC1, NIC2, and NIC3. Network identifier 1 may be generated with a unique value 10:20:30:40:50:60 to identify an environment where NIC1 is attached to a certain network while neither NIC2 nor NIC3 is attached to any network. Network identifier 2 may be generated to identify an environment where NIC1 is attached to a certain network, NIC2 is attached to another network, and NIC3 is not attached to any network. Network identifier 3 is an example with which to identify an environment where NIC1, NIC2, and NIC3 are respectively attached to certain networks. Network identifier 4 is an example identifier that is generated to identify an environment where NIC1 is attached to a network other than that to which it is attached for network identifier 3. In this way, the network environment to which the information processing apparatus 100 is currently attached may be uniquely identified. However, it is to be understood that this is not limiting and there are other available ways to uniquely identify the network environment to which the information processing apparatus 100 is attached.

Referring back to FIG. 1, the memory 140 may have stored therein first information and second information in connection with, e.g., use of the UPD 110 by the information processing apparatus 100. The first information includes a pair of printer information and a network identifier corresponding to a destination printer which is set as being in use by the UPD. The second information includes pairs of printer information and network identifiers corresponding to printers which have histories of having been used by the UPD.

As such, each of the first information and the second information is stored having associated therewith the above stated respective network identifier and the respective printer information regarding the printer corresponding to that network identifier. An example of the printer information includes pieces of information that are utilized in using the printer, including, for example, a printer name such as a printer name for presentation to the user, a device Id such as an identifier indicative of a device manufacturer, a device specification, device manufacture data, or the like, a printer UUID such as a uniquely assigned device UUID, an IP address for local printout, a cloud printer URI for remote printout, a current print channel of the printer such as a print channel indicative of whether the printer is available for a local printing scheme or for a remote printing scheme, a first flag such as a flag indicative of whether the destination printer has actually performed a print job, a second flag such as a flag indicative of whether the destination printer has automatically been selected, and so forth. A more detailed discussion of the values included in the printer information is provided below.

In an example, with the UPD 110 in control of a plurality of image forming devices 150, the first information may denote information that is stored having associated therewith printer information regarding a destination printer which is currently set to perform a print job and a network identifier of a network environment in which the destination printer is in use. This information may also be hereinafter referred to as “current destination information.” Further, the second information may denote information that is stored having associated therewith printer information regarding a printer which has actually been used by the UPD in a print job and network identifiers of network environments in which the printer has been used. This information may also be hereinafter referred to as “use history information.” The first and the second information may be used in an example of automatic printer setting for the UPD, examples of which will be described below.

In an example, the memory 140 may further include third information including information about a printer specified by the user. For example, the user may register his/her favorite image forming device in the additional information. This information may be hereinafter referred to as “favorite printer information,” which may also be used in an example automatic printer setting for the UPD.

Example operations of an automatic printer selection for the UPD 110 are described below.

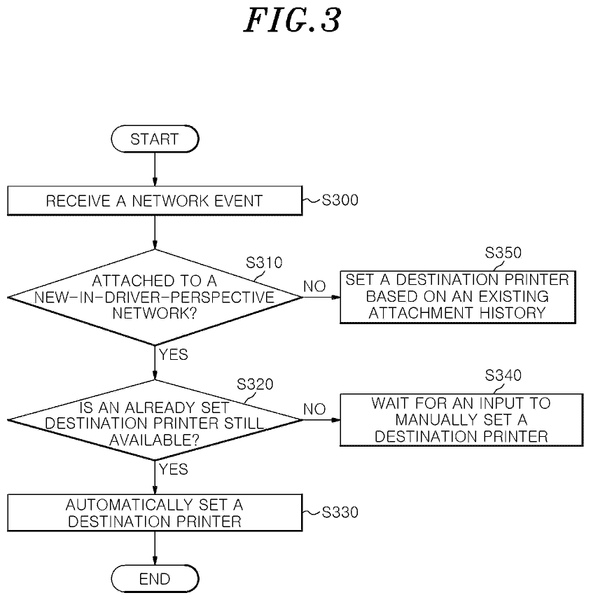

FIG. 3 is a flow diagram depicting operations of an automatic printer selection for a UPD according to an example.

In an example, the information processing apparatus may perform the operations of FIG. 3 using the processor of the information processing apparatus or an application, module, or machine readable instructions implemented by the processor. It is thus noted that these operations should not be construed as being performed by a specific component of the example information processing apparatus.

At operation S300, the information processing apparatus receives a network event from the operating system (OS). As described above, if there occurs an event related to a network to which the information processing apparatus is attached, the information processing apparatus, e.g., the processor thereof, may receive the network event from the OS. Such network event may be caused by a change of the network to which the information processing apparatus is attached, by the user starting up the information processing apparatus and logging in to the operating system, or by other circumstances.

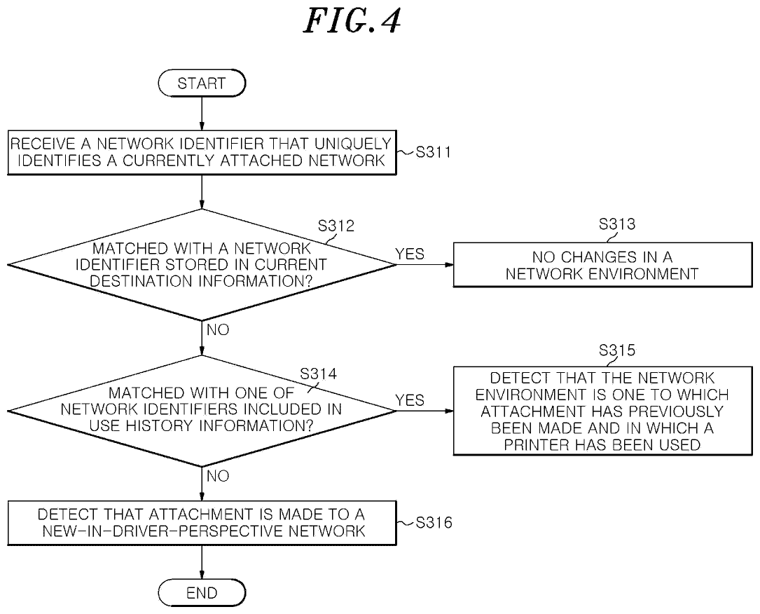

In response to receiving the network event, the processor of the information processing apparatus detects whether the information processing apparatus is attached to a new-in-driver-perspective network at operation S310. In the context of the present disclosure, the term “new-in-driver-perspective network” may refer to a network to which the information processing apparatus has not previously been attached or a network in which a destination printer of the UPD of the information processing apparatus has automatically been set and has not been used. In an example, the new-in-driver-perspective network includes a network to which the information processing apparatus is currently but has not previously been attached. In another example, the new-in-driver-perspective network includes a certain network to which the information processing apparatus has been attached and in which the user has not performed any print job while a destination printer has automatically been set for use by the UPD. This network may be regarded as a new network based on the information processing apparatus accessing the network again. In other words, in the context of the present disclosure, the term “new-in-driver-perspective network” refers to a network to which attachment is made that is, or is regarded as being, first seen by the UPD. With reference to FIG. 4, there are described examples of the foregoing, together with an example of a determination of whether attachment is made to a new-in-driver-perspective network.

FIG. 4 is a flow diagram depicting operations for detecting whether an information processing apparatus is attached to a new-in-driver-perspective network according to an example.

Referring to FIG. 4, in response to receiving the network event, the information processing apparatus may request and receive, from the OS in control of a network device, a network identifier which serves as information about the network to which the information processing apparatus is currently attached at operation S311. The information processing apparatus may detect, based on such received network identifier, whether the information processing apparatus is attached to a new-in-driver-perspective network. At operation S312, the information processing apparatus detects whether the received current network identifier is matched with the network identifier stored in the current destination information, i.e., the first information. The match between these network identifiers indicates that a printer has been set for use by the UPD before the occurrence of the network event on the information processing apparatus and remains unchanged after the occurrence of the network event. In that case, there are no changes between a network environment in which the printer has been available and a current network environment of the information processing apparatus, as indicated at operation S313. Therefore, in the currently attached network environment, the UPD may employ the already set destination printer based on the already stored current destination information.

If the received current network identifier is different from the network identifier stored in the current destination information, the information processing apparatus detects whether the current network identifier is matched with one of the network identifiers included in the use history information, i.e., the second information, at operation S314. The match between these network identifiers indicates that the information processing apparatus is re-attached to a network environment in which a printer has been used by the UPD before the occurrence of the network event, as indicated at operation S315. Therefore, setting a destination printer for use by the UPD in the currently attached network environment may be based on information which is acquired from the use history information and indicative of a printer that has been used as a destination printer in the same network environment.

If the current network identifier is not matched with any of the network identifiers included in the second information, the information processing apparatus detects that the information processing apparatus is attached to a new-in-driver-perspective network at operation S316.

Referring again to FIG. 3, if it is detected that the information processing apparatus is attached to a new-in-driver-perspective network, the processor of the information processing apparatus, at operation S320, from the current destination information, whether an already set destination printer of the UPD, i.e., a printer that is already set for use by the UPD in a previously attached network, is still available in the new-in-driver-perspective network, i.e., the network to which the information processing apparatus is currently attached while the attachment is, or is regarded as being, first made. If detected as being still available, the already set destination printer is automatically set at operation S330 as a destination printer of the UPD in the network to which the information processing apparatus is detected as being currently attached. As such, the UPD may automatically set a printer that is available to the UPD in the currently attached, new-in-driver-perspective network, to which the information processing apparatus is determined or regarded as not having been attached, without requiring the user to explicitly set a to-be-used printer.

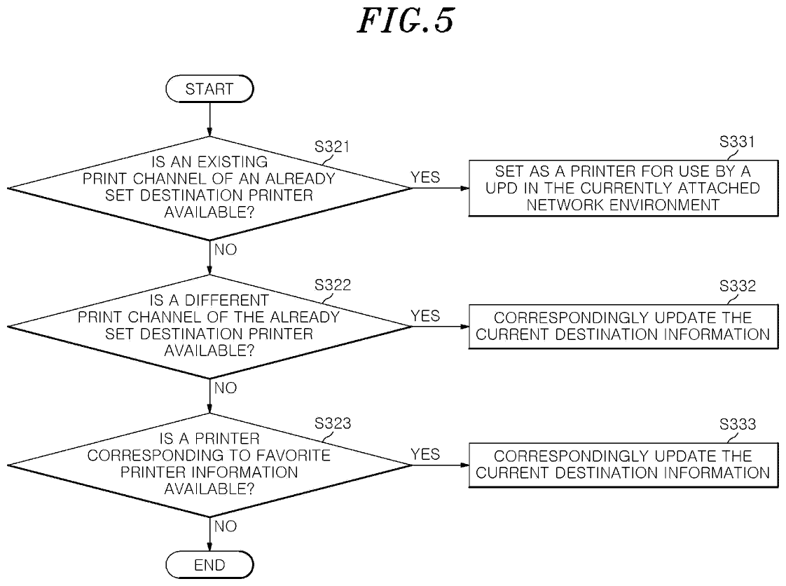

With reference to FIG. 5, there is described an example of detecting whether an already set destination printer of the UPD is still available in the network to which the information processing apparatus is currently attached.

FIG. 5 is a flow diagram depicting operations for detecting if an already set destination printer is available in a new-in-driver-perspective network according to an example.

Referring to FIG. 5, the information processing apparatus detects whether an existing print channel of the already set destination printer indicated in the current destination information is still available to the UPD in the currently attached network environment at operation S321. As described above, the current destination information includes printer information regarding a printer that is set as a destination printer. The printer information may include information regarding a print channel indicative of, e.g., whether the printer is available for a local printout scheme or for a remote printout scheme. In an example, if it is detected at operation S321 that the print channel of the printer indicated in the current destination information is set as one for local printout and that the printer is available through such local printout channel in the currently attached network environment, the printer is automatically set as a printer for use by the UPD in the currently attached, new-in-driver-perspective network. For example, in this case, the network identifier stored in the current destination information may be updated at operation S331 to a new network identifier while its corresponding printer information remains unchanged.

If it is detected that the existing print channel is not available, it is detected at operation S322 whether a print channel is available that is different from the existing print channel of the already set destination printer indicated in the current destination information. In an example, if the print channel of the printer indicated in the current destination information is set as one for local printout and the printer is not available through the local printout channel in the currently attached network environment, it is detected whether the same printer is available through a remote printout channel. If it is detected that the printer is available through the remote printout channel, the printer is automatically set at operation S332 as a printer that is available to the UPD in the currently attached new network environment. For example, in this case, the network identifier stored in the current destination information may be updated to a new network identifier and the print channel indicated in its corresponding printer information may be updated from the local printout to the remote printout channel.

Additionally, if it is detected that the already set destination printer indicated in the current destination information is unavailable with both of the existing and the different print channels, the information processing apparatus may detect, at operation S323, based on the favorite printer information, i.e., the third information, stored in the memory, whether a corresponding printer is available. For example, if the user's specified favorite printer is available in the new-in-driver-perspective network, the printer may be automatically set at operation S333 as a destination printer of the UPD. For example, in this case, the network identifier stored in the current destination information may be updated to a new network identifier and its corresponding printer information may be updated to the printer information regarding the favorite printer determined as being available.

Referring again to FIG. 3, if it is detected at operation S320 that the already set destination printer of the UPD is not available in the new-in-driver-perspective network to which the information processing apparatus is currently attached, the information processing apparatus may wait at operation S340 for the user to manually set a destination printer for use by the UPD. It should be appreciated that the process of such manual setting may be performed at a point in time other than based on a network event occurring. For example, a process of such manual setting may be carried out at a different point in time, such as based on the user performing a print job, or the like.

If it is determined at operation S310 that the information processing apparatus is not attached to the new-in-driver-perspective network, i.e., if it is determined that the network identifier received after the occurrence of the network event is matched with one of the network identifiers corresponding to a network environment to which attachment has been made before the occurrence of the network event, the currently received network identifier is determined as being matched with the network identifier included in the current destination information and/or the use history information, as determined as Yes at operations S312 or S314. For example, such case may include but is not limited to the case in which re-attachment is made to the same network environment by the user or the case in which the attached network environment is changed to that to which attachment has previously been made. As indicated by operation S350 of FIG. 3 and operations S313 and S315 of FIG. 4, the information processing apparatus may set a destination printer for use by the UPD based on the printer information stored in association with the existing network identifier that is detected as being matched.

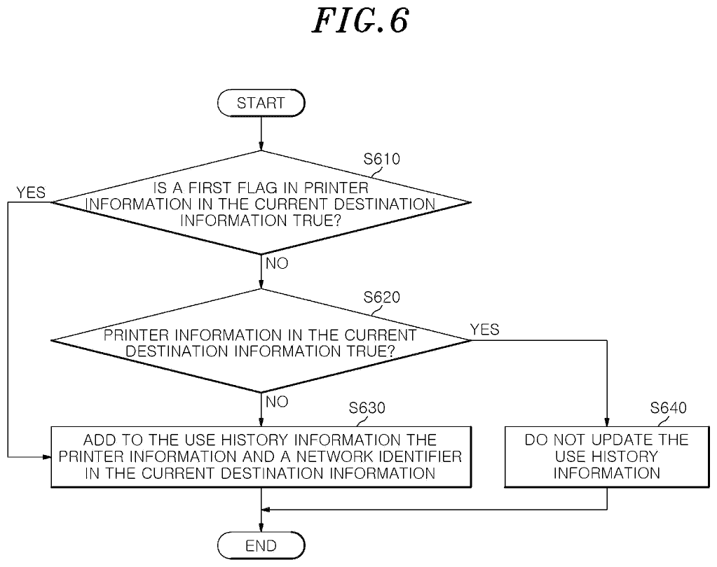

FIG. 6 is a diagram depicting operations for updating use history information for reference in some operations of an automatic printer setting for a UPD according to an example.

In an example, the printer information included in the current destination information regarding a destination printer that is set as being currently in use by the UPD may include a first flag and a second flag. The first flag may be indicative of whether the destination printer has actually performed a print job and the second flag may be indicative of whether the destination printer has automatically been selected by the UPD. The pair of the printer information and its corresponding network identifier recorded in the current destination information, i.e., the first information, may be added to the use history information, i.e., the second information, based on the values of the first and the second flags. The second information may be referred to in the operation of detecting whether the network environment to which the information processing apparatus is attached is matched with one of its previously attached network environments. Thus, it may be identified whether to add the network identifier and the corresponding printer information to the second information.

For example, in a situation in which a network event is caused by the information processing apparatus being attached to a network environment, the processor of the information processing apparatus may receive the network event and automatically select a destination printer for use by the UPD accordingly, irrespective of whether a print job is actually in progress, or before a print job is actually performed. The automatically selected destination printer may be recorded in the current destination information. Thereafter, if the user actually uses the printer to perform a print job, the pair of the network identifier and the printer information included in the current destination information may be added to the use history information. If attachment is later made to the same network environment, a destination printer may be set by referring to the use history information.

For example, with a network event caused by the information processing apparatus being attached to a network environment, if, according to the above-described example operations, a destination printer is automatically set which is available in the network environment and with which the user performs a print job, the first flag in the printer information is set to True. Further, if the destination printer is not one which is automatically set in accordance with an example of the present disclosure, the second flag in the printer information in the current destination information is set to False. This indicates that the destination printer which is set as being currently in use has manually been set by the user.

The use history information may be updated according to the values of the first and the second flags, an example of which is described below.

If it is desired to verify the recently updated use history information, for example, if upon the occurrence of the network event, a destination printer is to be set for use by the UPD in accordance with an example of the present disclosure, the information processing apparatus may detect whether to add certain information included in the current destination information to the use history information before the verification of the use history information. At operation S610, the information processing apparatus detects whether the first flag in the printer information in the current destination information is set to True. The first flag is set to True by the information processing apparatus if the destination printer has actually been used. Thus, if the first flag is set to True, the pair of the printer information and the network identifier in the current destination information is added to the use history information at operation S630. If the first flag is set to False, the already set destination printer has not actually been used in a print job. In that case, the second flag is detected at operation S620. The second flag is indicative of whether the destination printer has automatically been set in accordance with an example of the present disclosure. If the second flag is set to False, it indicates that the destination printer which is set as being currently in use has manually been set by the user. In that case, the current destination information is added at operation S630 to the use history information so that the user may be prevented from repeatedly setting the destination printer for use in the network environment even in a situation in which the printer has not actually performed a print job. At operation S640, the current destination information is not recorded in the use history information if the destination printer has automatically been indicated in the current destination information in accordance with an example of the present disclosure and has not actually performed a print job. Such updated use history information may be referred to in operation S314 of detecting whether the network environment to which the information processing apparatus is attached is matched with one of its previously attached network environments.

It may be understood that since updating of the use history information is performed as described above, the term “new-in-driver-perspective network” as used in the context of the present disclosure refers to a network to which attachment is made that is, or is regarded as being, first seen by the UPD. In other words, in the context of examples of the present disclosure, an example operation of detecting that the information processing apparatus is attached to a “new-in-driver-perspective network” includes an operation of detecting that the information processing apparatus is attached to a “new” network if the network is one to which the information processing apparatus has not previously been attached or if the network is one in which a print job has not actually been performed while automatic setting for the UPD of the information processing apparatus has been made after the reception of the network event.

In an example, the new-in-driver-perspective network includes a network to which the information processing apparatus is currently but has not previously been attached.

In another example, the new-in-driver-perspective network includes a certain network to which the information processing apparatus has been attached and in which the user has not performed any print job while a destination printer has automatically been set for use by the UPD. This network may be regarded as a new network in a situation in which the information processing apparatus accesses the network again. Therefore, if a printer has not actually been used but has automatically been set as a destination printer by the UPD, it is possible to prevent the printer from being additionally indicated in the use history information. As such, if it is detected that the information processing apparatus is reattached to a network that is regarded as being new in the perspective of the UPD, it is possible to perform the automatic printer setting operations again in accordance with an example of the present disclosure and to set a printer accordingly.

In another example, with the second flag set to False, it is possible to add the current destination information, i.e., the information regarding a printer that is set to be used by the UPD, into the use history information even in a situation in which a print job has not been performed, i.e., in a situation in which the first flag is set to False. Thus, a certain printer may be used in a prioritized manner if the printer is manually and explicitly specified by the user to be used in a certain network. This may prevent automatic printer setting that goes against the user's intent.

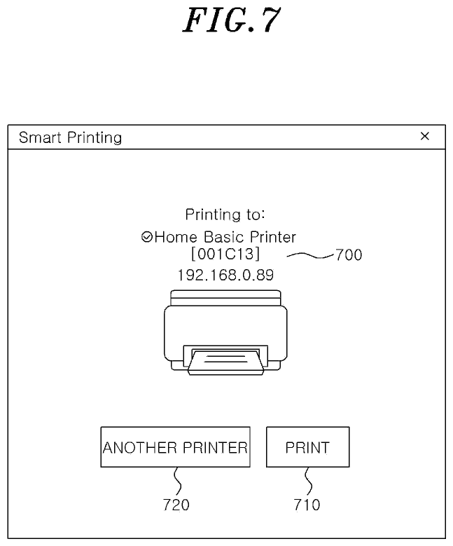

FIG. 7 shows an interface for presenting information regarding an automatically set destination printer according to an example.

Referring to FIG. 7, in an example in which the information processing apparatus is attached to a new network environment and a destination printer is automatically set for use by the UPD of the information processing apparatus, if the user performs a print job using the information processing apparatus, information 700 regarding the destination printer for use by the UPD may be provided to the user through a display of the information processing apparatus. There may be presented on the display an interface 710 through which the user may verify the information regarding the printer for use by the UPD and proceed with the print job. As such, a process of manual printer selection may be omitted even in a situation in which a first-time print job is performed in the new network environment. Also, there may be presented on the display an interface 720 through which the user may select his/her own desired printer after verifying the information 700 regarding the automatically selected printer.

In an example in which a UPD is installed in an information processing apparatus, even based on the information processing apparatus being moved into a new network environment to which it has not been attached, an image forming device may be automatically selected, under certain conditions, so as to be used through the UPD in the new network environment. This may reduce the user's inconvenience of selecting the image forming device to perform a print job through the UPD and provide the user with an enhanced user experience in performing the print job through the UPD in the new network environment.

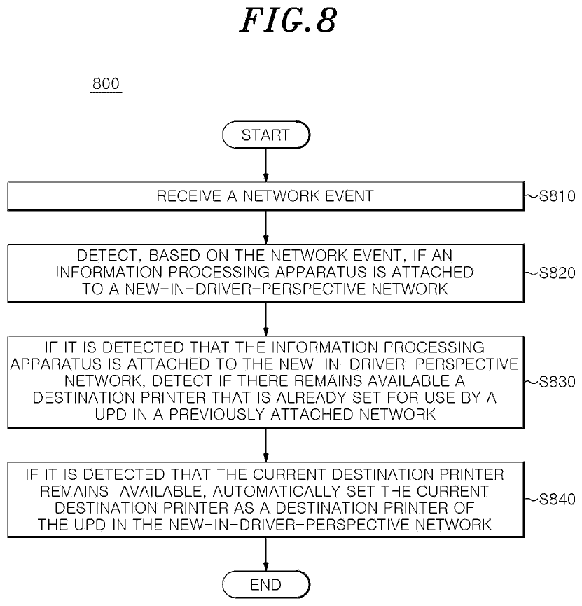

FIGS. 8 to 10 are flow diagrams illustrating example methods of setting up a UPD.

Referring to FIG. 8, a method 800 of setting up a UPD may be performed by an information processing apparatus that uses a UPD to control an image forming device.

The method 800 includes receiving, at operation S810, a network event, detecting, at operation S820, based on the network event, whether the information processing apparatus is attached to a new-in-driver-perspective network, if it is detected that the information processing apparatus is attached to the new-in-driver-perspective network, detecting, at operation S830, whether there remains available in the new-in-driver-perspective network a destination printer that is already set for use by a UPD of the information processing apparatus in a previously attached network, and, if it is detected that the already set destination printer remains available, automatically setting, at operation S840, the already set destination printer as a destination printer of the UPD in the new-in-driver-perspective network.

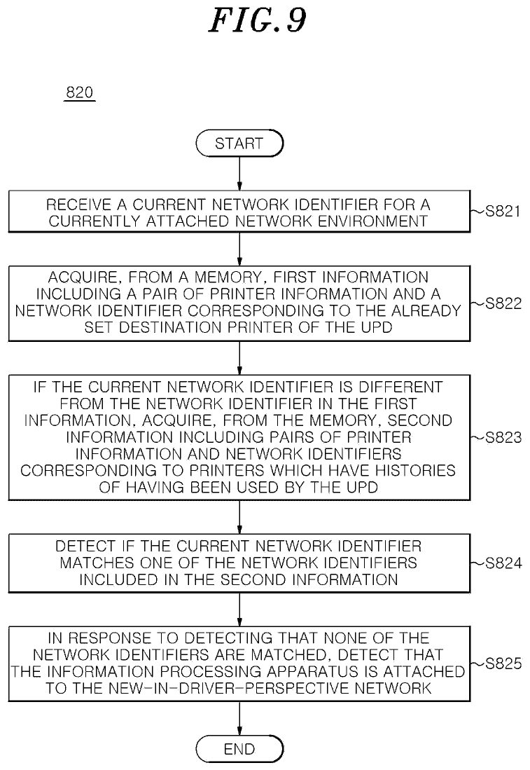

With reference to FIG. 9, a more detailed example of operation S820 of determining, based on the network event, whether the information processing apparatus is attached to the new-in-driver-perspective network is provided. As shown in FIG. 9, the detecting at operation S820 may include receiving, at operation S821, a current network identifier of a network environment to which the information processing apparatus is currently attached, acquiring, at operation S822, from a memory, first information including a pair of printer information and a network identifier corresponding to the already set destination printer of the UPD, if the current network identifier is different from the network identifier in the first information, acquiring, at operation S823, from the memory, second information including pairs of printer information and network identifiers corresponding to printers which have been used by the UPD, detecting, at operation S824, whether the current network identifier is matched with one of the network identifiers included in the second information, and, in response to detecting that the current network identifier is not matched with any of the network identifiers, detecting, at operation S825, that the information processing apparatus is attached to the new-in-driver-perspective network.

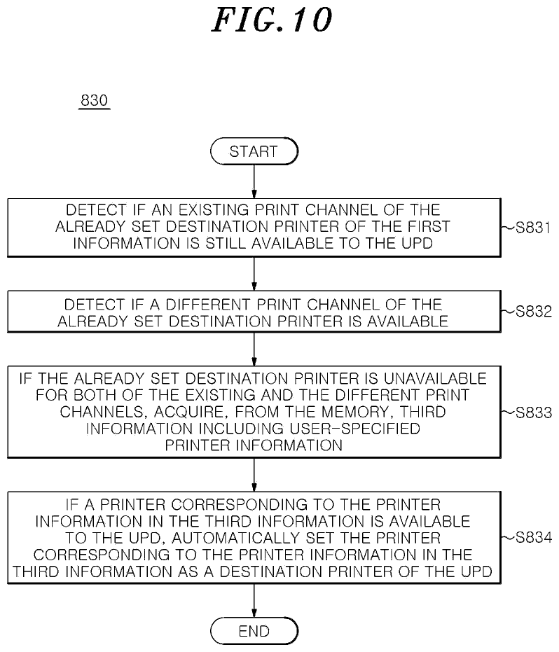

With reference to FIG. 10, a more detailed example of operation S830 of detecting whether there remains available in the new-in-driver-perspective network the already set destination printer is provided. As shown in FIG. 10, the detecting at operation S830 includes detecting, at operation S831, whether there remains available to the UPD an existing print channel of the already set destination printer indicated in the first information. The detecting at operation S830 further includes detecting, at operation S832, whether there is available to the UPD a print channel that is different from an existing print channel of the already set destination printer indicated in the first information. The detecting at operation S830 may further include, if the already set destination printer indicated in the first information is unavailable for both of the existing and the different print channels, acquiring, at operation S833, from the memory, third information including user-specified printer information, and, if a printer corresponding to the printer information in the third information is available to the UPD, automatically setting, at operation S834, the printer corresponding to the printer information in the third information as the destination printer of the UPD.

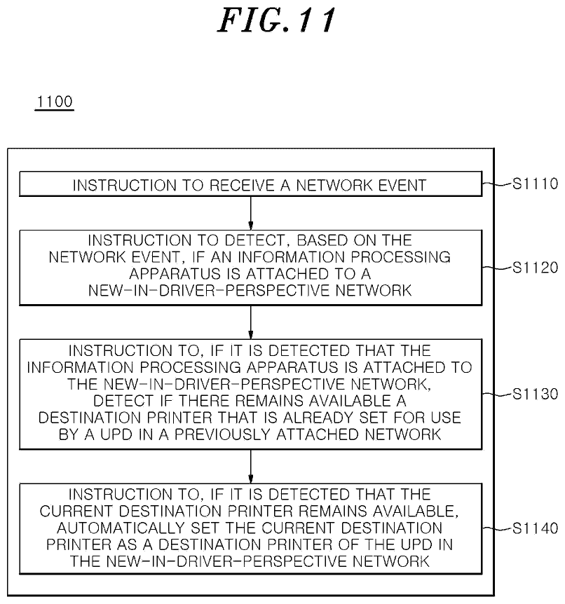

FIG. 11 is a schematic illustration of a non-transitory computer readable recording medium including example instructions.

Referring to FIG. 11, a non-transitory computer readable recording medium 1100 stores a computer program that is executable by a processor and programmable to implement example operations of the aforementioned methodology, such as the example operations of the information processing apparatus described above with respect to FIGS. 1 to 7 and the example operations of the method described above with respect to FIGS. 8 to 10.

The computer program on the non-transitory computer readable recording medium 1100 may include a set of program instructions that direct the processor to perform example operations.

Referring to FIG. 11, the non-transitory computer readable recording medium 1100 may include instructions S1110 to receive a network event, instructions S1120 to detect, based on the network event, whether the information processing apparatus is attached to a new-in-driver-perspective network, if it is detected that the information processing apparatus is attached to the new-in-driver-perspective network, instructions S1130 to detect whether there remains available in the new-in-driver-perspective network a destination printer that is already set for use by a UPD of the information processing apparatus in a previously attached network, and, if it is detected that the already set destination printer remains available, instructions S1140 to automatically set the already set destination printer as a destination printer of the UPD in the new-in-driver-perspective network.

In an example, upon execution of the computer program stored in the non-transitory computer readable recording medium 1100, the example operations included in instructions S1110, S1120, S1130, and S1140 illustrated in FIG. 11, as well as the example operations described above with respect to FIGS. 1 to 7 and the example method operations described above with respect to FIGS. 8 to 10, may be performed by the computer, for example, the above-described information processing apparatus.

The term “non-transitory computer readable recording medium” as used herein refers to a medium that is capable of semi-permanently storing data and is readable by an apparatus, rather than a medium, e.g., a register, a cache, a volatile memory device, etc., that temporarily stores data. For example, the foregoing program instructions may be stored and provided in a CD, a DVD, a hard disk, a Blu-ray disc, a USB, a memory card, a ROM device, or any of other types of non-transitory readable media.

In an example, the methodology disclosed herein may be incorporated into a computer program product. The computer program product may be available as a product for trading between a seller and a buyer. The computer program product may be distributed in the form of a machine-readable storage medium, e.g., compact disc read only memory (CD-ROM), or distributed online through an application store, e.g., PlayStore™. For the online distribution, at least a portion of the computer program product may be temporarily stored, or temporarily created, in a storage medium such as a server of the manufacturer, a server of the application store, or a storage medium such as memory of a relay server.

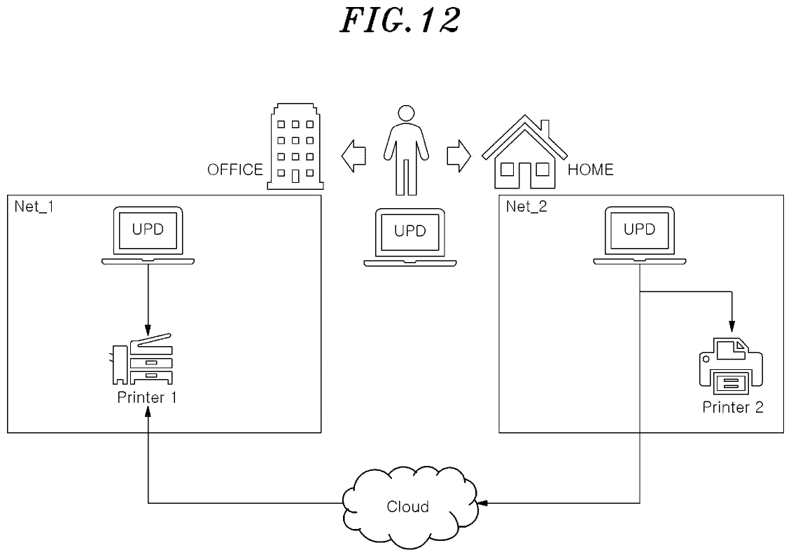

FIG. 12 is a diagram illustrating an environment in which a destination printer may be automatically set for a UPD according to an example.

Referring to FIG. 12, a user has installed a UPD in an information processing apparatus, e.g., his/her laptop, and, in his/her office, searched for and selected Printer1 for a print job. As such, Printer1 performs the print job via a local channel in the office environment. The information processing apparatus generates a network identifier Net_1 of the office environment and stores, in a memory, current destination information in which Net_1 is associated with information regarding Printer1. Thereafter, in a situation in which the user returns to his/her home and turns on the laptop, a network event occurs based on which the laptop checks that it is attached to a new network environment. The laptop also checks if Printer1, which is already selected for use by the UPD, is available in the new network environment. It is detected that Printer1 is unavailable for a local printing scheme. It is also checked whether Printer1 provides support, and is available, for a remote printing scheme such as a cloud printing function. If Printer1 is available for the remote printing scheme, i.e., Printer1 uses a remote print channel, then the Printer1 is set for use by the UPD in the attached network environment within the home. Thereafter, if the user attempts printing through the UPD, the user may be presented with currently set printer information indicating that Printer1 is used for the remote printing scheme and may proceed with the printing accordingly.

In this example, in a situation in which the user comes back home from the office, he/she may remotely use Printer1, which has locally been used in the office, in particular with the laptop provided by his/her employer for business purposes and governed by a policy that prevents use of an unauthorized printer, e.g., a printer at his/her home, for a printout. This may ensure safe printing of a secure document and eliminates the user's inconvenience of searching for and setting a new printer.

On the other hand, upon the printing at his/her home, the user may change the to-be-used printer from automatically set Printer1 to another available printer, e.g., Printer2 located in his/her home, after verifying the currently set printer information indicating that Printer1 is used for the remote printing scheme. In this case, since the corresponding information is stored in an existing use history, Printer2 may be set by default for use in a situation in which the user performs a print job at his/her home.

The foregoing description has been presented to illustrate and describe some examples. It should be understood that many modifications and variations are possible in light of the above teaching. In various examples, suitable results may be achieved if the above-described techniques are performed in a different order, and/or if some of the components of the above-described systems, architectures, devices, circuits, and the like are coupled or combined in a different manner, or substituted for or replaced by other components or equivalents thereof.

Although the foregoing examples are described in the context of image forming devices, it should be understood that the present disclosure is not limited to such image forming devices and is applicable in other situations where a universal device driver is to be used for utilization of a plurality of devices.

Therefore, the scope of the disclosure is not to be limited to the precise form disclosed, but rather defined by the following claims and equivalents thereof.

What is claimed is:

1. An information processing apparatus, comprising:
a processor; and
a memory to store instructions executable by the processor,
wherein, by executing the instructions, the processor is to:
receive a network event;
detect, based on the network event, whether the information processing apparatus is attached to a new-in-driver-perspective network;
if it is detected that the information processing apparatus is attached to the new-in-driver-perspective network, detect whether there remains available in the new-in-driver-perspective network a destination printer that is already set for use by a universal printer driver (UPD) of the information processing apparatus in a previously attached network; and
if it is detected that the already set destination printer remains available, automatically setting the already set destination printer as a destination printer of the UPD in the new-in-driver-perspective network,
wherein the new-in-driver-perspective network comprises a network to which the information processing apparatus has not been attached or a network in which a destination printer of the UPD has automatically been set and not been used.

2. The information processing apparatus of claim 1,
wherein the memory comprises first information and second information,
wherein the first information comprises a pair of printer information and a network identifier corresponding to the already set destination printer of the UPD,
wherein the second information comprises pairs of printer information and network identifiers corresponding to printers which have been used by the UPD, and
wherein the processor is to detect, based on the network event, whether the information processing apparatus is attached to the new-in-driver-perspective network by:
receiving a current network identifier of a network environment to which the information processing apparatus is currently attached;
if the current network identifier is different from the network identifier in the first information, detecting whether the current network identifier is matched with one of the network identifiers comprised in the second information; and
in response to detecting that the current network identifier is not matched with any of the network identifiers, detecting that the information processing apparatus is attached to the new-in-driver-perspective network.

3. The information processing apparatus of claim 2, wherein the processor is to detect whether there remains available in the new-in-driver-perspective network the already set destination printer by detecting whether there remains available to the UPD an existing print channel of the already set destination printer indicated in the first information.

4. The information processing apparatus of claim 2, wherein the processor is to detect whether there remains available in the new-in-driver-perspective network the already set destination printer by detecting whether there is available to the UPD a print channel that is different from an existing print channel of the already set destination printer indicated in the first information.

5. The information processing apparatus of claim 4, wherein the different print channel comprises a remote print channel.

6. The information processing apparatus of claim 2,
wherein the memory further comprises third information,
wherein the third information comprises user-specified printer information, and
wherein the processor is further to, if the already set destination printer indicated in the first information is not available to the UPD and a printer corresponding to the printer information in the third information is available to the UPD, automatically set the printer corresponding to the printer information in the third information as the destination printer of the UPD.

7. The information processing apparatus of claim 1, wherein the processor is further to display, on a user interface of the information processing apparatus, information regarding the automatically set destination printer.

8. The information processing apparatus of claim 2,
wherein the printer information in the first information comprises a first flag and a second flag.
wherein the first flag is indicative of whether the already set destination printer has actually performed a print job through the UPD,
wherein the second flag is indicative of whether the already set destination printer has automatically been selected by the UPD, and
wherein the processor is further to, after receiving the network event, add the pair of the printer information and the network identifier in the first information to the second information if the first flag is set to True or the second flag is set to False.

9. A method of setting up a universal printer driver, the method comprising:
receiving a network event;
detecting, based on the network event, whether an information processing apparatus is attached to a new-in-driver-perspective network;
if it is detected that the information processing apparatus is attached to the new-in-driver-perspective network, detecting whether there remains available in the new-in-driver-perspective network a destination printer that is already set for use by a universal printer driver (UPD) of the information processing apparatus in a previously attached network; and
if it is detected that the already set destination printer remains available, automatically setting the already set destination printer as a destination printer of the UPD in the new-in-driver-perspective network,
wherein the new-in-driver-perspective network comprises a network to which the information processing apparatus has not been attached or a network in which a destination printer of the UPD has automatically been set and not been used.

10. The method of claim 9, wherein the detecting, based on the network event, whether an information processing apparatus is attached to the new-in-driver-perspective network comprises:
receiving a current network identifier of a network environment to which the information processing apparatus is currently attached;
acquiring, from a memory, first information comprising a pair of printer information and a network identifier corresponding to the already set destination printer of the UPD;
if the current network identifier is different from the network identifier in the first information, acquiring, from the memory, second information comprising pairs of printer information and network identifiers corresponding to printers which have been used by the UPD;
detecting whether the current network identifier is matched with one of the network identifiers comprised in the second information; and
in response to detecting that the current network identifier is not matched with any of the network identifiers, detecting that the information processing apparatus is attached to the new-in-driver-perspective network.

11. The method of claim 10, wherein the detecting of whether there remains available in the new-in-driver-perspective network the already set destination printer comprises detecting whether there remains available to the UPD an existing print channel of the already set destination printer indicated in the first information.

12. The method of claim 10, wherein the detecting of whether there remains available in the new-in-driver-perspective network the already set destination printer comprises detecting whether there is available to the UPD a print channel that is different from an existing print channel of the already set destination printer indicated in the first information.

13. The method of claim 10, further comprising:
acquiring, from the memory, third information comprising user-specified printer information; and
if the already set destination printer indicated in the first information is not available to the UPD and a printer corresponding to the printer information in the third information is available to the UPD, automatically setting the printer corresponding to the printer information in the third information as the destination printer of the UPD.

14. A non-transitory computer readable recording medium having instructions stored therein for a method of setting up a universal printer driver, the non-transitory computer readable recording medium comprising:
instructions to receive a network event;
instructions to detect, based on the network event, whether an information processing apparatus is attached to a new-in-driver-perspective network;
instructions to, if it is detected that the information processing apparatus is attached to the new-in-driver-perspective network, detect whether there remains available in the new-in-driver-perspective network a destination printer that is already set for use by a universal printer driver (UPD) of the information processing apparatus in a previously attached network; and
instructions to, if it is detected that the already set destination printer remains available, automatically set the already set destination printer as a destination printer of the UPD in the new-in-driver-perspective network,
wherein the new-in-driver-perspective network comprises a network to which the information processing apparatus has not been attached or a network in which a destination printer of the UPD has automatically been set and not been used.

15. The non-transitory computer readable recording medium of claim 14, wherein the instructions to detect, based on the network event, whether the information processing apparatus is attached to the new-in-driver-perspective network comprise:
instructions to receive a current network identifier of a network environment to which the information processing apparatus is currently attached;
instructions to acquire, from a memory, first information comprising a pair of printer information and a network identifier corresponding to the already set destination printer of the UPD;
instructions to, if the current network identifier is different from the network identifier in the first information, acquiring, from the memory, second information comprising pairs of printer information and network identifiers corresponding to printers which have been used by the UPD;
instructions to detect whether the current network identifier is matched with one of the network identifiers comprised in the second information; and
instructions to, in response to detecting that the current network identifier is not matched with any of the network identifiers, detect that the information processing apparatus is attached to the new-in-driver-perspective network.
